(19) United States
(12) Patent Application Publication
(10) Pub. No.: US 2016/0161344 A1
(43) Pub. Date: Jun. 9, 2016

(54) Temperature Measurement Using a Magnetic Ranging Tool

(71) Applicant: APPLIED TECHNOLOGIES ASSOCIATES, INC., Paso Robles, CA (US)

(72) Inventors: Arthur LAPORTA, Silver Spring, MD (US); Clinton James MOSS, Edmonton (CA); Douglas Thatcher RIDGWAY, Edmonton (CA); Troy MARTIN, Edmonton (CA)

(21) Appl. No.: 14/958,611

(22) Filed: Dec. 3, 2015

Related U.S. Application Data
(60) Provisional application No. 62/088,539, filed on Dec. 6, 2014.

(51) Int. Cl. G01K 7/18; G01K 13/00

(52) U.S. Cl. CPC G01K 7/183; G01K 13/00

(57) ABSTRACT

A method of measuring the temperature in a wellbore may include positioning a conductor within the wellbore where the conductor has a temperature-dependent resistivity. By measuring the resistance of the conductor, the temperature of the wellbore may be determined. The conductor may be coupled to a power supply by a wireline. The resistivity of the wireline may be measured or calibrated for changes in its resistivity in response to wellbore temperature.

### CROSS-REFERENCE TO RELATED APPLICATIONS

This application is a nonprovisional application which claims priority from U.S. provisional application No. 62/088,539, filed Dec. 6, 2014, which is hereby incorporated by reference in its entirety.

### TECHNICAL FIELD/FIELD OF THE DISCLOSURE

The present disclosure relates generally to downhole measurements and specifically to measurement of temperature in a wellbore.

### BACKGROUND OF THE DISCLOSURE

During certain wellbore operations, knowledge of the operating conditions within the wellbore may be useful. For example, a temperature measurement may be used to, for example and without limitation, assess wellbore conditions, monitor downhole equipment, or measure progress of a downhole operation. As an example, in a wellbore used in a steam assisted gravity drainage (SAGD) operation, the temperature and pressure of the formation and wellbore may be monitored as a well is drilled. In order to conduct a ranging measurement, i.e. to measure the distance between the wellbore being drilled and a target well, an electromagnet assembly may be placed in the target wellbore to produce a magnetic field detectable by a magnetometer in the wellbore being drilled.

### SUMMARY

The present disclosure provides for a method for determining a temperature of a wellbore. The method may include positioning a conductor in the wellbore. The conductor may be formed from a material having a temperature-dependent resistivity. The conductor may be coupled to a power supply by a wireline. The resistance of the conductor defines a coil resistance R_{coil}. The method may include measuring R_{coil} and determining the temperature of the wellbore based at least in part on R_{coil}.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a downhole tool positioned in a wellbore consistent with at least one embodiment of the present disclosure.

FIG. 2 depicts a schematic view of a downhole tool consistent with at least one embodiment of the present disclosure.

FIG. 3 depicts a schematic view of a downhole tool consistent with at least one embodiment of the present disclosure.

FIG. 4 depicts a calibration chart of resistance to temperature for a conductor of a downhole tool consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

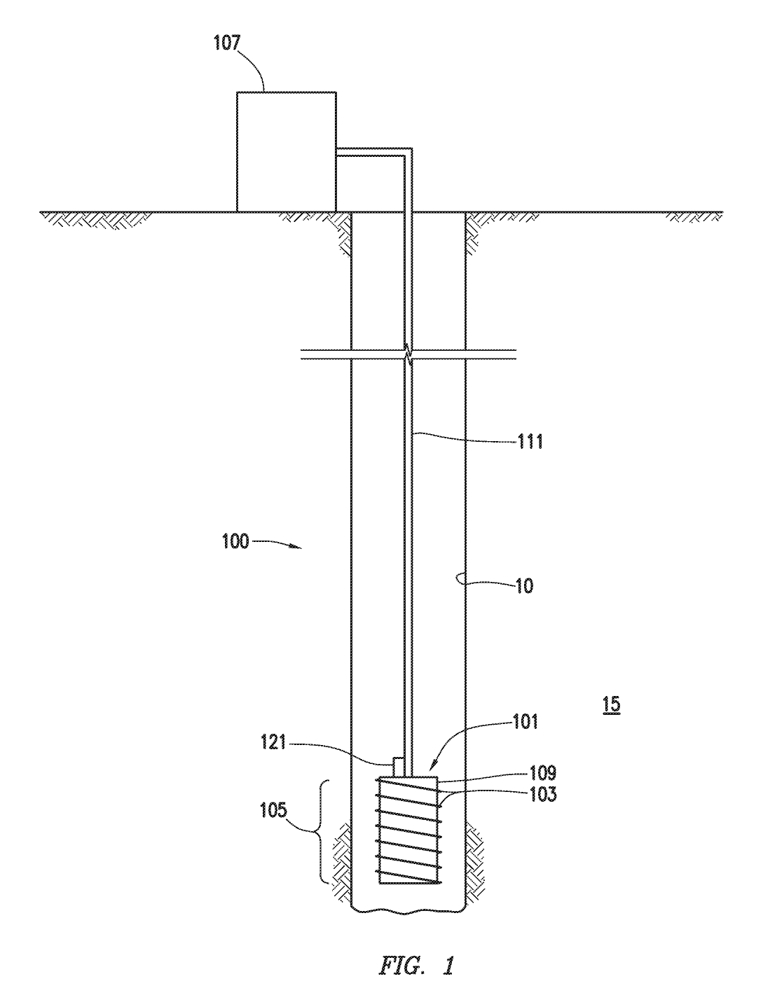

FIG. 1 depicts wellbore 10. Disposed within wellbore 10 is downhole tool 100. Downhole tool 100 may include one or more components which include a length of conductive material. For example and without limitation, downhole tool 100 may include electromagnet 101. The conductive material may be formed as conductor 103 which may be formed into one or more windings of coil 105 of electromagnet 101. When current is fed thereto, electromagnet 101 may produce an electric field. In some embodiments, electromagnet 101 may be used as part of a magnetic ranging tool (MRT) or may be used as part of a downhole electric motor such as, for example and without limitation, a submersible pump, drill motor, or any other motor. Conductor 103 may be positioned in downhole tool 100 for any purpose and used as described herein. Although described herein in terms of windings of “coils”, one having ordinary skill in the art with the benefit of this disclosure will understand that any conductor in downhole tool 100 may be utilized as described herein without deviating from the scope of this disclosure. In some embodiments, electromagnet 101 may include ferromagnetic core 109.

Power supply 107 may be coupled to electromagnet 101 through wireline 111 as discussed further herein below. Power supply 107 may provide electric current to electromagnet 101 to, for example and without limitation, generate a magnetic field in wellbore 10 and the surrounding formation 15. The magnetic field may be detected by another tool (not shown), such as a magnetometer in a tool in a second wellbore, and may be used to locate wellbore 10 relative thereto. In certain embodiments, power supply 107 may provide direct current, alternating current, or any combination thereof without deviating from the scope of this disclosure. Although depicted as being at the surface, one having ordinary skill in the art with the benefit of this disclosure will understand that power supply 107 may be positioned in the wellbore without deviating from the scope of this disclosure.

In some embodiments, conductor 103 may be formed from a conductive material having a resistivity which is temperature dependent. Resistivity, as understood in the art, is a measure of how strongly a material resists the flow of electric current. Resistance of the material is a function of the resistivity, length, and cross-sectional area of the material. By measuring the resistance of coil 105, the temperature of wellbore 10 at electromagnet 101 may be determined. In some embodiments, for example and without limitation, conductor 103 may be formed from copper or aluminum alloy wire. In some embodiments, the temperature to be measured in the wellbore may range from 50° C.-3500° C., and a measurement, for example and without limitation, to an accuracy of ±10° C. or better may be desirable.

The temperature may be determined according to:

ρ=ρ₀(1+α[T−T₀])

where ρ is the resistivity of the material of conductor 103, T is the temperature in wellbore 10, ρ₀ is the resistivity of conductor 103 at temperature T₀, and α is the temperature coefficient of the material of conductor 103. In terms of resistance R of a conductor 103,

R=R₀(1+α[T−T₀])

where conductor 103 has a resistance R₀ at temperature T₀. Merely as an example, in an embodiment in which conductor 103 is formed from copper having a temperature coefficient at 298K of α_{c}=0.00386°/C, where coil 105 has a nominal resistance of 30Ω, the temperature dependence of the resistance of coil 105 would be:

R−R₀=R₀α(T−T₀)=(30Ω)(0.00386° C.⁻¹)(T−T₀)=(0.116Ω/° C.)(T−T₀)

Therefore, a change of temperature in wellbore 10 of 1° C. would result a measurable change in resistance of 0.116Ω.

In some embodiments, the resistance of coil 105 may be measured during its normal operation by monitoring the potential difference in volts that power supply 107 produces to maintain a constant current in electromagnet 101. In some embodiments, the resistance of coil 105 may be measured by disconnecting it from power supply 107 and using a resistance meter to determine its resistance. However, in some embodiments, the resistance of leads in wireline 111 may affect the measured temperature and may be compensated for.

The resistance of coil 105 (R_{coil}) may be determined by subtracting the resistance of wireline 111 (Rₗᵢₙₑ) from the total measured resistance (Rₜₒₜₐₗ) as described herein below.

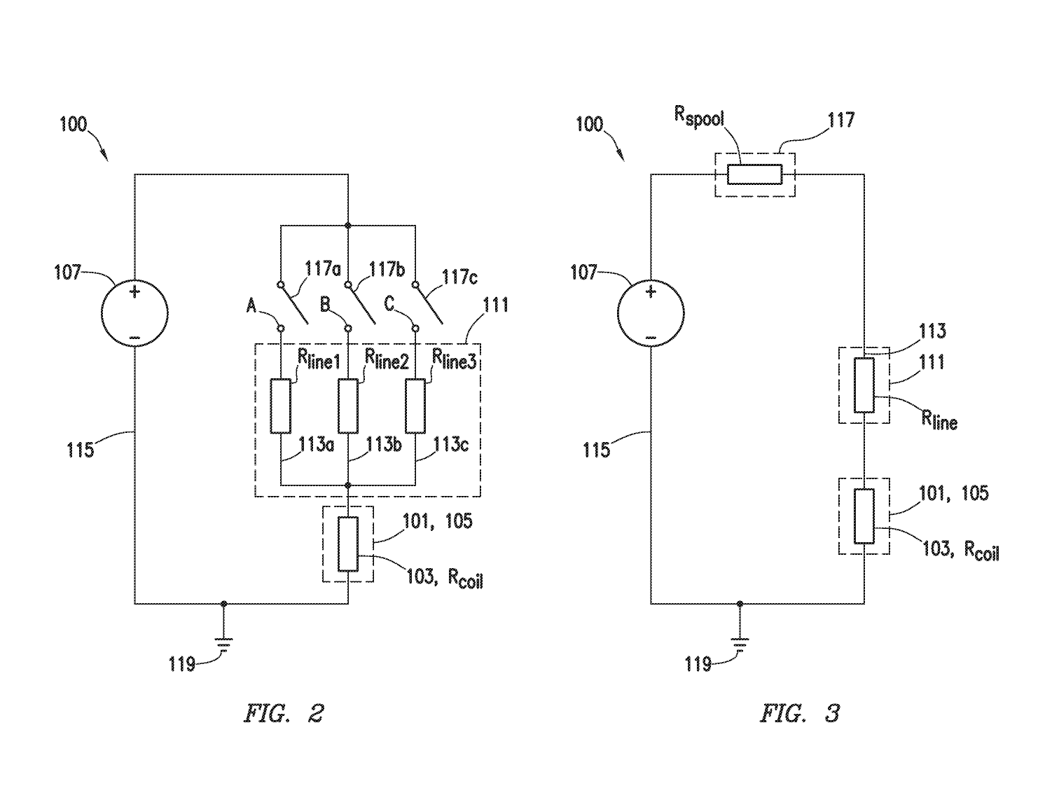

In some embodiments, as depicted in FIG. 2, power may be supplied to electromagnet 101 by a multiconductor wireline 111, here depicted as including supply leads 113a-c and return lead 115. One lead of power supply 107 may be coupled to supply leads 113a-c, here indicated as a positive lead, and the other to return lead 115 as the negative or return lead. In some embodiments, return lead 115 may be coupled to ground 119. Resistance of this circuit may be measured at power supply 107 during operation of downhole tool 100.

In some embodiments, switches 117a-c may be coupled between power supply 107 and each of supply leads 113a-c. In some embodiments, the resistances of supply leads 113a-c may be measured in advance. In some embodiments, the resistances of supply leads 113a-c (Rₗᵢₙₑ₁, Rₗᵢₙₑ₂, and Rₗᵢₙₑ₃, respectively) may be determined when in operation as follows. The resistance of the wireline supply leads may be given by:

$${R}_{total} = {R}_{coil} + {R}_{line} = {R}_{coil} + {( \frac{1}{{R}_{line 1}} + \frac{1}{{R}_{line 2}} + \frac{1}{{R}_{line 3}} )}^{- 1}$$

Switches 117a-c may be selectively opened and the resistance between points A and B (R_{AB}), A and C (R_{AC}), and B and C (R_{BC}) measured wherein points A, B, and C are the upper ends of supply leads 113a-c respectively. The resistance of each supply lead 113a-c may thereby be calculated according to:

R_{AB}=Rₗᵢₙₑ₁+Rₗᵢₙₑ₂ Rₗᵢₙₑ₁=(R_{AB}+R_{AC}−R_{BC})/2

R_{BC}=Rₗᵢₙₑ₂+Rₗᵢₙₑ₃ Rₗᵢₙₑ₂=(R_{AB}+R_{BC}−R_{AC})/2

R_{AC}=Rₗᵢₙₑ₁+Rₗᵢₙₑ₃ Rₗᵢₙₑ₃=(R_{BC}+R_{AC}−R_{AB})/2

Thus, the individual line resistances of supply leads 113a-c may be determined. Although described utilizing three supply leads 113a-c, one having ordinary skill in the art with the benefit of this disclosure will understand that any number of supply leads may be utilized and their individual resistances calculated from measurements of the resistance of various combinations of leads as previously described. In some embodiments, this calculation may be repeated when downhole tool 100 is in wellbore 10 to compensate for any change in the resistance of supply leads 113a-c due to changes in the conditions within wellbore 10, such as due to temperature changes or changes in the depth of the coil.

In some embodiments, a single supply lead 113 may be utilized as depicted in FIG. 3. In some embodiments, an estimation of the total line resistance may be determined by measuring the resistance of supply lead 113 when on spool 117, and by modelling the increase in resistance of supply lead 113 due to the temperature profile of wellbore 10 when supply lead 113 is positioned therein. If the temperature of wellbore 10 is measured as a function of depth as electromagnet 101 is lowered into wellbore 10, the full temperature profile of the deployed section of supply lead 113 may be known. The increase in resistance (ΔR) may be determined from the fraction of wireline resistance that is in-hole, the average temperature of the in-hole portion of supply lead 113 (T_{deployed}), and the temperature of the portion of supply lead 113 remaining on spool 117 (Tₛₚₒₒₗ). The resistance of supply lead 113 may be given by:

$${R}_{line} = {R}_{spool} ( 1 + Δ R ) = {R}_{spool} ( 1 + ( \frac{z}{L} ) {α}_{ω} ( {T}_{deployed} - {T}_{spool} ) )$$

Where α_{ω} is the temperature coefficient of the wireline leads, z is the length of supply lead 113 deployed, or the depth of electromagnet 101 in wellbore 10, L is the total length of supply lead 113, and Rₛₚₒₒₗ is the total resistance of supply lead 113 when entirely on spool 117.

Once the resistance Rₗᵢₙₑ of wireline 111 is determined, the resistance R_{coil} of coil 105 may be determined according to:

R_{coil}=Rₜₒₜₐₗ−Rₗᵢₙₑ

R_{coil} may then be used to determine the temperature in wellbore 10 at electromagnet 101 by:

$$T = {T}_{0} + \frac{( \frac{{R}_{total} - {R}_{line}}{{R}_{0}} - 1 )}{α}$$

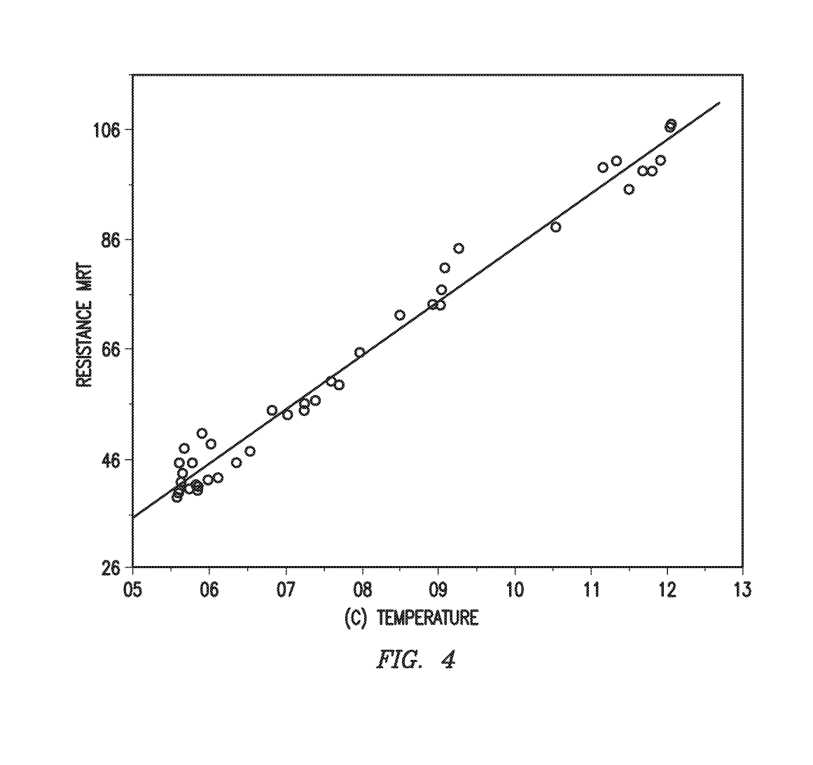

In some embodiments, the temperature of wellbore 10 at electromagnet 101 may be determined utilizing a calibration based on the known resistance and temperature coefficients of the coil and wireline leads. In some embodiments, a separate temperature sensor (depicted in FIG. 1 as temperature sensor 121) may be included with downhole tool 100. By exposing coil 105 to various temperatures and measuring the temperatures with temperature sensor 121, the resistance response of coil 105 to varying temperatures may be determined. An exemplary calibration is depicted in FIG. 4. Calibration may be undertaken in wellbore 10 or in a test apparatus capable of simulating the desired temperature range.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method for determining a temperature of a wellbore comprising:
positioning a conductor in the wellbore, the conductor formed from a material having a temperature-dependent resistivity, the conductor coupled to a power supply by a wireline, the resistance of the conductor defining a coil resistance R_{coil};
measuring R_{coil}; and
determining the temperature of the wellbore based at least in part on R_{coil}.

2. The method of claim 1, wherein measuring R_{coil} further comprises:
measuring the total resistance of the wireline and conductor, the total resistance defining Rₜₒₜₐₗ;
determining the resistance of the wireline, defining Rₗᵢₙₑ; and
calculating R_{coil} according to:
R_{coil}=Rₜₒₜₐₗ−Rₗᵢₙₑ.

3. The method of claim 2, wherein the wireline is a multiconductor wireline.

4. The method of claim 3, wherein the wireline includes three supply leads coupled in parallel, each supply lead having a resistance defined as Rₗᵢₙₑ₁, Rₗᵢₙₑ₂, and Rₗᵢₙₑ₃ respectively, such that Rₜₒₜₐₗ is given by:
$${R}_{total} = {R}_{coil} + {( \frac{1}{{R}_{line 1}} + \frac{1}{{R}_{line 2}} + \frac{1}{{R}_{line 3}} )}^{- 1} .$$

5. The method of claim 4, wherein each of the three supply leads are coupled to the power supply through a switch, and determining the resistance of the wireline comprises:
opening each switch to isolate the upper ends of the three supply leads;
measuring a resistance between the upper end of a first supply lead and the upper end of a second supply lead of the three supply leads defined as R_{AB}, such that:
R_{AB}=Rₗᵢₙₑ₁+Rₗᵢₙₑ₂;
measuring a resistance between the upper end of the first supply lead and the upper end of a third supply lead of the three supply leads defined as R_{AC}, such that:
R_{AC}=Rₗᵢₙₑ₁+Rₗᵢₙₑ₃;
measuring a resistance between the upper end of the second supply lead and the upper end of the third supply lead defined as R_{BC}, such that:
R_{BC}=Rₗᵢₙₑ₂+Rₗᵢₙₑ₃;
calculating the resistances of each supply lead according to:
Rₗᵢₙₑ₁=(R_{AB}+R_{AC}−R_{BC})/2;
Rₗᵢₙₑ₂=(R_{AB}+R_{BC}−R_{AC})/2; and
Rₗᵢₙₑ₃=(R_{BC}+R_{AC}−R_{AB})/2.

6. The method of claim 2, wherein the wireline is at least partially positioned on a spool outside of the wellbore, and determining the resistance of the wireline, Rₗᵢₙₑ, comprises:
measuring the resistance of the wireline when entirely positioned on the spool outside of the wellbore, defining Rₛₚₒₒₗ, at a known temperature defining Tₛₚₒₒₗ;
determining an average temperature of the wellbore defining T_{deployed}; and
determining an increase in resistance of the wireline, defining ΔR, while the wireline is at least partially in the wellbore based at least in part on the average temperature of the wellbore.

7. The method of claim 6, wherein the increase in resistance of the wireline, ΔR is given by:
$$Δ R = {R}_{spool} ( \frac{z}{L} ) α ( {T}_{deployed} - {T}_{spool} ) ,$$
where z is the length of the wireline positioned in the wellbore, L is the total length of the wireline, and α_{ω} is the temperature coefficient of the wireline leads.

8. The method of claim 6, wherein the average temperature is determined using the conductor.

9. The method of claim 6, wherein the average temperature is determined using a temperature sensor.

10. The method of claim 2, wherein the temperature of the wellbore, T, is determined according to:
$$T = {T}_{0} + \frac{( \frac{{R}_{total} - {R}_{line}}{{R}_{0}} - 1 )}{α} ,$$
where R₀ is the resistance of the conductor at a temperature T₀, and α is the temperature coefficient of the material of the conductor.

11. The method of claim 2, further comprising:
exposing the conductor to various temperatures;
measuring the resistance of the conductor at each temperature;
determining the response of the resistance of the conductor to temperature; and
wherein the temperature of the wellbore, T, is determined based at least in part on the determined response of the resistance of the conductor to temperature.

12. The method of claim 11, wherein the conductor is exposed to various temperatures in the wellbore.

13. The method of claim 11, wherein temperature readings are determined with a temperature sensor.

14. The method of claim 11, wherein the conductor is exposed to various temperatures in a test apparatus.

15. The method of claim 1, wherein the conductor forms one or more windings of a coil.
